(19) United States
(12) Patent Application Publication
(10) Pub. No.: US 2006/0121248 A1
(43) Pub. Date: Jun. 8, 2006

(54) Plastic body provided with a microstructured surface

(75) Inventors: Hans Lorenz, Darmstadt (DE); Helmut Haering, Reichelsheim (DE); Volker Mende, Darmstadt (DE); Christoph Krohmer, Stockstadt (DE); Werner Hoess, Griesheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ROEHM GMBH & CO. KG, DARMSTADT (DE)

(21) Appl. No.: 10/524,840

(22) PCT Filed: Apr. 21, 2004
(86) PCT No.: PCT/EP04/04202

§ 371 Date: Feb. 17, 2005

(30) Foreign Application Priority Data
Jul. 2, 2003 (DE) 103 29 938.6

(51) Int. Cl. B29C 47/06; B29C 59/02; G11B 5/64

(52) U.S. Cl. 428/141; 264/173.16; 264/210.2; 264/284; 428/156

(57) ABSTRACT

The invention relates to a process for the production of a plastics article with a microstructured surface via production of a composite composed of a backing layer composed of a thermoplastic or thermoelastic with one or more structure layers, characterized in that the structure layer(s) is/are composed of from 1 to 100% by weight of a polymethacrylate moulding composition which comprises from 80 to 100% by weight of free-radical-polymerized methyl methacrylate units and from 0 to 20% by weight of other comonomers capable of free-radical polymerization, and which has an average (weight-average) molar mass Mw of from 30 000 g/mol to 70 000 g/mol and, where appropriate, is present in a. mixture with up to 99% by weight of a polymethacrylate moulding composition which is composed of from 80 to 100% by weight of free-radical-polymerized methyl methacrylate units and from 0 to 20% by weight of other comonomers capable of free-radical polymerization, and which has an average (weight-average) molar mass Mw of from 90 000 g/mol to 200 000 g/mol and the structure layer(s) obtain microstructuring via known structuring processes, after production of the composite. The invention further relates to the plastics articles themselves which are capable of production according to the invention, and also to their uses.

The invention relates to plastics articles with a microstructured surface, to a process for their production, and also to their uses.

### PRIOR ART

Solid articles produced industrially and having microstructured surfaces are known per se, and adopt the physical principle of friction-reduction known from the natural world, for example from sharkskin. Because of this, they are sometimes given the trivial name “sharkskins”. If suitable structuring is present, a reduction in frictional or flow resistance can be observed when a turbulent flow of gas or of liquid passes over the material.

DE 36 09 541 A1 describes a reduced flow resistance resulting from a surface of an article over which a turbulent flow passes, and which has grooves running in the direction of flow, these being separated from one another by sharp-edged ribs, the surface being associated with reduced wall shear stress. The arrangement of the ribs here is not in continuous parallel rows, but has the ribs mutually offset.

EP 0 846 617 A2 describes a surface for a wall over which a turbulent flow passes with a primary direction of flow, with ribs oriented in the direction of flow and separated laterally with respect to the primary direction of flow, the height of the ribs being from 45 to 60% of the distance separating the ribs. The ribs are wedge-shaped, the wedge angle being from 20 to 50°. The valleys between the rows may be flat or curved.

DE 44 07 468 A1 describes a process for the extrusion of plastics panels with very finely structured surface by means of an extrusion system equipped with extruder and with a three-roller polishing stack, comprising one roller with structuring surface, characterized in that the system has been designed for coextrusion and the plastics panels are surface-structured by way of two extruders in the form a coextrudate composed of a highly viscous substrate moulding composition and of a low-viscosity moulding composition applied by extrusion, and by way of the three-roller polishing stack. Thermoplastics which may be used are polyacrylates, in particular polymethyl methacrylate, polycarbonate, polyolefins, LDPE, HDPE, polypropylene, polyethylene terephthalate, polyvinyl chloride, polystyrene or polyamide. The type of plastic of which the low-viscosity moulding composition is composed may be the same as that of which the substrate moulding composition is composed, but the low-viscosity moulding composition may also be composed of a plastic sufficiently compatible with that type. The low-viscosity moulding composition may advantageously comprise release agents, e.g. higher alcohols, examples of amounts being up to 0.34% by weight. The ratio of the MFR melt viscosity indices (DIN 57 735 or ASTM 1238-70) of the two moulding compositions is about 1:10. The temperature of the embossing roller is preferably higher by up to 70° C. than the glass transition temperature of the low-viscosity moulding composition. Plastics panels with very finely embossed structures, e.g. linear or centric Fresnel lenses or semiholo grams, can be produced advantageously.

EP-A 1 189 987 describes an impact-modified polymethacrylate moulding composition, characterized by a Vicat softening point of at least 90° C. to ISO 306 (B 50), a notched impact strength NIS (Charpy) of at least 3.0 kJ/m² at 23° C. to ISO 179/1eA, and an MVR (230° C./3.8 kg) flowability of at least 11 cm³/10 min to ISO 1133, obtainable by mixing a) from 80 to 98% by weight of an impact-modified polymethacrylate moulding composition with b) from 20 to 2% by weight of a low-molecular-weight polymethacrylate moulding composition in the melt, where the impact-resistant moulding composition is composed of from 70 to 99% by weight of a matrix composed of from 80 to 100% by weight of free-radical-polymerized methyl methacrylate units and, where appropriate, of from 0 to 20% by weight of other comonomers capable of free-radical polymerization, and comprises from 1 to 30% by weight of an impact modifier, and the low-molecular-weight polymethacrylate moulding composition is composed of from 80 to 100% by weight of free-radical-polymerized methyl methacrylate units and of from 0 to 20% by weight of other comonomers capable of free-radical polymerization, and has a viscosity number (η_{sp/c}) in the range from 25 to 35 ml/g, measured in chloroform to ISO 1628. The molar mass Mw of the matrix polymer may be in the range from 90 000 to 200 000 g/mol. The impact-modified moulding composition may advantageously be used in injection moulding.

### OBJECT AND ACHIEVEMENT THEREOF

DE 44 07 468 A1 describes a process for the extrusion of plastics panels with a very finely structured surface, e.g. Fresnel lenses. However, it has been found that structures which are even finer, in particular microstructures, cannot be reproduced in a completely satisfactory manner. An object was therefore to improve the process of DE 44 07 468 A1 in such a way that it can also be used to produce plastics articles with a fine degree of reproduction of microstructured surfaces.

The object is achieved by way of a process for the production of a plastics article with a microstructured surface via production of a composite composed of a backing layer composed of a thermoplastic or thermoelastic with one or more structure layers,

characterized in that

structure layer(s) is/are composed of from 1 to 100% by weight of a polymethacrylate moulding composition which comprises from 80 to 100% by weight of free-radical-polymerized methyl methacrylate units and from 0 to 20% by weight of other comonomers capable of free-radical polymerization and which has an average (weight-average) molar mass Mw of from 30 000 to 70 000 g/mol

and, where appropriate, is present in a mixture with up to 99% by weight of a polymethacrylate moulding composition which is composed of from 80 to 100% by weight of free-radical-polymerized methyl methacrylate units and from 0 to 20% by weight of other comonomers capable of free-radical polymerization and which has an average (weight-average) molar mass Mw of from 90 000 to 200 000 g/mol

and the structure layer(s) obtain microstructuring via known structuring processes, after production of the composite.

The invention also provides the plastics articles themselves, and their uses.

The achievement of the object is based on a modification of the plastic of the structure layer. The structure layer here may be produced entirely or to some extent from the low-molecular-weight polymethyl methacrylate moulding composition described in EP-A 1 189 987 for modifying the flow properties of impact-modified polymethacrylate moulding compositions for injection moulding. However, it was not foreseeable that the low-molecular-weight moulding composition described in that publication, alone or in a mixture with higher-molecular-weight moulding compositions, would be particularly suitable for the transfer of microstructures by means of moulding processes.

### DESCRIPTION OF THE INVENTION

The inventive process encompasses the production of a plastics article with a microstructured surface via production of a composite composed of a backing layer composed of a thermoplastic or thermoelastic with one or more structure layers whose melt viscosity is lower than that of the backing layer.

A microstructured surface means a surface which has microstructures, the dimensions of whose geometries are in the range from 1 to 1000 μm, preferably from 2 to 500 μm, in particular from 5 to 200 μm. The dimensions of geometries mean, by way of example, heights, radii, diameters and/or roughnesses, these being the terms which can be used to describe microstructures, e.g. grooves, pimples, pyramids, ribs, prism structures and the like. The height:width aspect ratios of these microstructures may be from 0.3 to 10, preferably from 0.5 to 5 and in particular from 0.7 to 3.

A microstructured surface is also intended to mean the microstructure component of macrostructures. By way of example, the edge radius or the peak of prism microstructures or of pyramid macrostructures are in turn microstructures and may correspondingly likewise be very precisely reproduced by using the inventive process.

An inventive plastics article with a microstructured surface is produced by producing a composite composed of a backing layer composed of a thermoplastic or thermoelastic with one or more structure layers whose melt viscosity is/are lower than that of the backing layer.

The composite of backing layer and structure layer may be generated by means of plastics processing techniques known per se, e.g. via coextrusion, application of the structure layer to the backing layer by lamination, or application of the structure layer to the backing layer by lacquering.

The Backing Layer

The backing layer supports the structure layer(s). The melt viscosity of the plastic of the backing layer is generally higher than that of the plastic of a structure layer.

The thickness of the backing layer may be practically as desired, e.g. in the range from 0.4 to 100 mm, preferably from 0.05 to 10 mm and particularly preferably from 0.07 to 8 mm.

The shape of the backing layer may be practically as desired, e.g. that of a simple sheet, of a foil, of a panel having cavities, in particular a twin-web sandwich panel, a multiple-web sandwich panel, or a lattice panel, or a tube or a rod of angled or round shape.

By way of example, the plastic of the backing layer may be cast or extruded polymethyl methacrylate, impact-modified polymethyl methacrylate, polycarbonate, polystyrene, styrene-acrylonitrile, polyethylene terephthalate, glycol-modified polyethylene terephthalate, polyvinyl chloride, polyolefins, such as polyethylene or polypropylene, acrylonitrile-butadiene-styrene (ABS), or a mixture (blend) of various thermoplastics.

A backing layer is preferably composed of a polymethyl methacrylate or of a plastic compatible with polymethyl methacrylate. This ensures good bonding of the structure layer(s) composed of polymethyl methacrylate.

Preference is given to a backing layer composed of a polymethacrylate moulding composition which is composed of from 80 to 100% by weight, preferably from 95 to 99% by weight, of free-radical-polymerized methyl methacrylate units and of from 0 to 20% by weight, preferably from 1 to 5% by weight, of other comonomers capable of free-radical polymerization, and which has an average (weight-average) molar mass Mw of from 90 000 to 200 000 g/mol, in particular from 120 000 to 190 000 g/mol, particularly preferably from 150 000 to 190 000 g/mol. Preferred comonomers are C₁-C₄-alkyl(meth)acrylates, in particular methyl acrylate, ethyl acrylate or butyl methacrylate. Particular preference is given to a moulding composition composed of from 95 to 99% by weight of methyl methacrylate and from 1 to 5% by weight of methyl acrylate.

The plastic of the backing layer may have a viscosity number (η_{sp/c}) in the range from 50 to 80 ml/g, preferably from 70 to 75 ml/g, measured in chloroform to ISO 1628 Part 6, corresponding to an average (weight-average) molecular weight Mw of from 90 000 to 200 000, preferably from 100 000 to 130 000 or from 130 000 to 160 000, in particular from 150 000 to 190 000.

However, the backing layer may also be composed of a plastic which is incompatible with, or has poor compatibility with, polymethyl methacrylate. In this case, however, it is advantageous to equip the backing layer with an intermediate layer which has been coextruded, laminated, or applied by lacquering, and which promotes adhesion, in order to ensure good bonding of the structure layer composed of polymethyl methacrylate.

Where appropriate, the incompatibility of the plastics may also be utilized in order to separate the composite after the microstructuring has been applied. This can be advantageous for producing thin embossed foils, the backing layer serving merely to absorb the counteracting forces during the embossing process.

Adhesion-promoting layers have properties of adhesion with respect to both of the plastics to be bonded. By way of example, a polymethyl methacrylate layer may be bonded to a plastic incompatible with polymethyl methacrylate by way of an adhesion-promoting layer which has, by way of example, alcohol or ether functions or has epoxy groups, e.g. composed of glycidyl methacrylate residues. By way of example, a suitable adhesion promoter may be a silane, e.g. methacryloyloxypropyltrimethoxysilane (MEMO). Suitable adhesion promoters for the various combinations of plastics are familiar to the person skilled in the art.

The Structure Layer

The structure layer serves for the reproduction of microstructures in the course of production of the composite with the backing layer, in particular during the coextrusion process, or at any desired subsequent juncture, preferably when the composite was produced via lamination or lacquering. The structure layer may be present as a layer on one or both sides of the backing layer.

The thickness of the structure layer may be in the range from, by way of example, 1 to 1000 μm, preferably from 2 to 500 μm, and particularly preferably from 5 to 200 μm.

The structure layer is composed of from 1 to 100% by weight, preferably from 20 to 80% by weight, particularly preferably from 30 to 70% by weight, of a polymethacrylate moulding composition which is composed of from 80 to 100% by weight, preferably from 95 to 100% by weight, of free-radical-polymerized methyl methacrylate units and comprises from 0 to 20% by weight, preferably from 0 to 5% by weight, of other comonomers capable of free-radical polymerization, and which has an average (weight-average) molar mass Mw of from 30 000 g/mol to 70 000 g/mol.

The low-molecular-weight polymethacrylate moulding composition preferably has a viscosity number (η_{sp/c}) of from 25 to 35 ml/g, preferably from 27 to 33 ml/g, measured in chloroform to ISO 1628 Part 6, corresponding to an average (weight-average) molecular weight Mw of from 30 000 to 70 000, in particular from 40 000 to 60 000.

By way of example, the molecular weight may be determined by the differential scanning calorimetry method (DSC) or via gel chromatography, using polymethyl methacrylate calibration standards or using straight-line calibration systems, where these correlate with the viscosity number.

If the proportion of the abovementioned low-molecular-weight moulding composition is lower than 100% by weight, the material is a mixture with up to 99% by weight, preferably from 80 to 20% by weight, particularly preferably from 70 to 30% by weight, of a polymethacrylate moulding composition which is composed of from 80 to 100% by weight, preferably from 80 to 95% by weight, in particular from 82 to 88% by weight, of free-radical-polymerized methyl methacrylate units and of from 0 to 20% by weight of other comonomers capable of free-radical polymerization, and which has an average (weight-average) molar mass Mw of from 90 000 to 200 000, in particular from 100 000 to 150 000 (g/mol). Preference is given to a moulding composition composed of from 80 to 98% by weight, particularly from 82 to 88% by weight, of methyl methacrylate and from 2 to 20% by weight, particularly preferably from 12 to 18% by weight, of methyl acrylate.

The higher-molecular-weight polymethacrylate moulding composition preferably has a viscosity number (η_{sp/c}) in the range from 50 to 80 ml/g, preferably from 50 to 55 ml/g, measured in chloroform to ISO 1628 Part 6, corresponding to an average (weight-average) molecular weight Mw of from 90 000 to 200 000, in particular from 100 000 to 150 000.

The other comonomers are not in principle critical for the workability of the invention, as long as, besides the functional vinyl group involved in the free-radical polymerization, they do not contain any other functional groups such as acid groups or hydroxy groups. By way of example, suitable comonomers are esters of methacrylate acid (e.g. ethyl methacrylate, butyl methacrylate, hexyl methacrylate, cyclohexyl methacrylate), esters of acrylic acid (e.g. methyl acrylate, ethyl acrylate, butyl acrylate, hexyl acrylate, cyclohexyl acrylate) or styrene and styrene derivatives, such as α-methylstyrene or p-methylstyrene. Preferred comonomers are C₁-C₄-alkyl(meth)acrylates, in particular methyl acrylate, ethyl acrylate or butyl methacrylate.

The thickness of the structure layer may be in the range from, by way of example, 1 to 1000 μm, preferably from 2 to 500 μm, and particularly preferably from 5 to 200 μm.

Application of the Microstructure

The microstructured surface of the structure layer is obtained via known structuring processes, e.g. embossing, hot embossing, structuring pull-off systems or belts, the belts being discontinuous or continuous.

The production of solids or appropriate mouldings, in particular from metal, for the reproduction of microstructures on plastics is known, e.g. moulding, forming, ablation, or deposition methods, or via embossing processes, machining, casting, injection moulding, high-energy radiation (e.g. laser beams) or photoetching methods, etc.

After the discharge of a coextrudate composed of the melts of the backing layer and of the structure layer from the extrusion die of an extrusion system, the microstructures may be embossed into the structure layer(s) in the molten state in an attached polishing-roller stack, by means of one or more embossing rollers.

The microstructures may also be transferred into the previously solidified structure layer by way of subsequent hot embossing. This is clearly a particularly useful method when the composites were produced by lamination or lacquering.

Plastics Articles

The plastics articles obtainable are preferably a composite composed of a backing layer and of one or more microstructured structure layers. However, according to the invention it is also possible to obtain plastics articles which are composed solely of the microstructured structure layer, if the structure layer and the backing layer are subsequently separated.

The inventive plastics article may be a simple sheet or a foil, a corrugated sheet, a panel having cavities, in particular a twin-web sandwich panel, a multiweb sandwich panel or a lattice panel, or a tube or a rod of angled, round, elliptical or oval shape.

Uses

The inventive plastics articles may advantageously be used, by way of example, as components with friction-reducing surfaces for the reduction of friction where air or water flows over surfaces of vehicles (aircraft, water-craft or land vehicles), or as lines and containers for the reduction of friction where fluids flow at high speeds in lines and containers, for the controlled mixing of fluids, for the production of surfaces with modified acoustic properties, for the production of micro- or nanotitre plates, for the reduction of adhesion of contaminants to surfaces requiring protection, as antimicrobial surfaces, as surfaces which direct light, conduct light, refract light and/or diffusely scatter light, and/or as antireflective surfaces.

Advantageous Effects of the Invention

The inventive process permits the production of plastics articles with microstructured surfaces on one or more solids. In particular, finer structures can be reproduced, when comparison is made with known processes. By way of example, microscopic examination reveals the advantageous improvements in reproduction properties.

For example, groove structures with triangular cross sections having greater height than width, i.e. aspect ratios above 1, can be realized with good results for groove widths in the range from 10 to 20 μm. In contrast, although grooves of this type can be produced at this width using prior-art emboss layers, they are reproduced with undesirable rounding, overall and particularly on the upper side, the aspect ratios therefore mostly remaining below 1. Improvements can likewise be seen in the reproduction of pimple-shaped depressions whose order of size is, by way of example, only 1 μm, the peak and valley structures being reproduced more regularly and to a fuller extent, so that they are almost identical with the intended emboss structure.

The good reproducibility of the emboss structures in the structure layer makes it possible to operate with embossing pressures lower than could be used hitherto. This also permits the use of thinner and/or softer backing layers, e.g. backing layers composed of polymethyl methacrylates with relatively low average molecular weights M_{w}, e.g. from 100 000 to 150 000. The number of suitable combinations of materials is thus increased.

1. A process for the production of a plastics article with a microstructured surface via production of a composite comprised of a backing layer comprised of a thermoplastic or thermoelastic with one or more structure layers,
wherein
the structure layer(s) is/are comprised of from 1 to 100% by weight of a polymethacrylate moulding composition which comprises from 80 to 100% by weight of free-radical-polymerized methyl methacrylate units and from 0 to 20% by weight of other comonomers capable of free-radical polymerization and which has an average (weight-average) molar mass Mw of from 30 000 to 70 000 g/mol
and, where appropriate, is present in a mixture with up to 99% by weight of a polymethacrylate moulding composition which is comprised of from 80 to 100% by weight of free-radical-polymerized methyl methacrylate units and from 0 to 20% by weight of other comonomers capable of free-radical polymerization and which has an average (weight-average) molar mass Mw of from 90 000 to 200 000 g/mol
and the structure layer(s) obtain microstructuring via known structuring processes, after production of the composite.

2. The process according to claim 1, wherein the plastic of the structure layer has a viscosity number (η_{sp/c}) of from 25 to 50 ml/g, measured in chloroform to ISO 1628 Part 6.

3. The process according to claim 1, wherein the composite of backing layer and structure layer is generated via coextrusion, application of the structure layer to the backing layer by lamination, or application of the structure layer to the backing layer by lacquering.

4. The process according to claim 1, wherein the polymethyl methacrylate moulding compositions of the structure layer comprise, as other comonomers, C₁-C₄-alkyl(meth)acrylates.

5. The process according to claim 1, wherein the thickness of the structure layer is in the range from 1 to 1000 μm.

6. The process according to claim 1, wherein the dimensions of the geometries of the microstructures are in the range from 1 to 1000 μm.

7. The process according to claim 1, wherein the height:width aspect ratios of the microstructures are from 0.3 to 10.

8. The process according to claim 1, wherein, after the discharge of a coextrudate comprised of the melts of the backing layer and of the structure layer from the extrusion die of an extrusion system, the microstructures are embossed into the structure layer(s) in the molten state in an attached polishing-roller stack, by means of one or more embossing rollers.

9. The process according to claim 1, wherein the microstructures are transferred via subsequent hot embossing into the previously solidified structure layer(s).

10. The process according to claim 1, wherein the backing layer is comprised of a polymethyl methacrylate plastic or of a plastic compatible with polymethyl methacrylate.

11. The process according to claim 1, wherein the backing layer is comprised of a plastic which is incompatible with, or has poor compatibility with, polymethyl methacrylate, but is equipped with (an) intermediate layer(s) which has been coextruded, laminated, or applied by lacquering, and which promotes adhesion.

12. The process according to claim 1, wherein the backing layer is comprised of a plastic which is incompatible with, or has poor compatibility with, polymethyl methacrylate, but is not equipped with any intermediate layer which has been coextruded, laminated, or applied by lacquering, and which promotes adhesion, and, after the microstructure has been applied, the composite is separated in order to obtain the microstructured structure layer alone.

13. A plastics article which can be produced by the process as claimed in claim 1.

14. The plastics article according to claim 13, wherein said plastics article is a composite comprised of a backing layer and of one or more structure layers with microstructured surfaces.

15. The plastics article according to claim 13, wherein said plastics article is comprised of a structure layer with a microstructured surface and the backing layer is comprised of a plastic which is incompatible with, or has poor compatibility with, polymethyl methacrylate, but is not equipped with any intermediate layer which has been coextruded, laminated, or applied by lacquering, and which promotes adhesion, and, after the microstructure has been applied, the composite is separated in order to obtain the microstructured structure layer alone.

16. The plastics article according to claim 13, wherein said plastics article is a simple sheet, a corrugated sheet, a panel having cavities, or a tube or rod, the shape of which is angular or round, elliptical or oval.

17. (canceled)

18. A method for modifying a surface of an object, said method comprising:
placing said plastics article according to claim 13
on a surface of a vehicle where air water flows over said surface of said vehicle to reduce friction; or
on a line or a container where fluids flow at high speeds to reduce friction; or
on a container and mixing one or more fluids in said container to control mixing of said one or more fluids; or
on a surface of a first article to produce a surface having a modified acoustic property; or
on a surface of a second article to produce a surface having reduced adhesion of contaminants; or
on a surface of a third article to produce antimicrobial surface; or
on a surface of a fourth article to produce a surface which directs light, conducts light, refracts light, diffusely scatters light, reflects light, does not reflect light, or performs a mixture of functions thereof.
